(19) United States
(12) Patent Application Publication
(10) Pub. No.: US 2026/0049701 A1
(43) Pub. Date: Feb. 19, 2026

(54) DOWNLIGHT WITH MULTIPLE SWITCHABLE LIGHTING MODES AND IMPLEMENTATION METHOD OF DOWNLIGHT

(71) Applicant: Hengdian Group Tospo Lighting Co., Ltd., Jinhua (CN)

(72) Inventors: Tao LI, Jinhua (CN); Junchu SI, Jinhua (CN); Linlin CHENG, Jinhua (CN); Jinghang ZHOU, Jinhua (CN); Miao HAN, Jinhua (CN); Heng LI, Jinhua (CN); Hao CHEN, Jinhua (CN); Wei LIU, Jinhua (CN); Kaixuan GE, Jinhua (CN)

(73) Assignee: Hengdian Group Tospo Lighting Co., Ltd., Jinhua (CN)

(21) Appl. No.: 19/302,009

(22) Filed: Aug. 17, 2025

(30) Foreign Application Priority Data
Aug. 16, 2024 (CN) 2024111271176

(51) Int. Cl. F21S 8/02; F21V 23/02; F21V 29/71

(52) U.S. Cl. CPC F21S 8/026; F21V 23/023; F21V 29/713; F21V 2200/20

(57) ABSTRACT

A downlight with multiple switchable lighting modes is disclosed. The downlight includes a ring body. A light guide ring is disposed inside the ring body. A radiator is disposed above the light guide ring. A diffusion cover is disposed on the inner side of the radiator. A light guide plate is disposed above the diffusion cover. Reflective sheet is disposed above the light guide plate. A second light source is connected to an inner wall of the radiator. A first light source is disposed between the ring body and the radiator. A backplate is connected above the ring body.

### CROSS-REFERENCE TO RELATED APPLICATION

This application claims priority to and the benefit of Chinese patent application No. 202411127117.6, filed Aug. 16, 2024, the contents of which is incorporated by reference herein in its entirety.

### TECHNICAL FIELD

The present disclosure pertains to downlights, in particular to a downlight with multiple switchable lighting modes and an implementation method of the downlight.

### BACKGROUND

Downlights are one type of concealed lamps embedded in ceilings, with all light directed downward, belonging to direct light distribution. Different reflectors, lenses, shutters, or bulbs may be used to achieve different lighting effects. The downlight saves space and can enhance ambient softness. If a cozy atmosphere is desired, a plurality of downlights may be installed to reduce spatial oppressive feeling.

At present, there is only one group of light emitting bodies in the downlight on the market, which has a single lighting mode. With increasing demands for product diversity, one lighting mode can no longer meet requirements of some customers. When the requirements of the customers cannot be met, customers must purchase different types of lamps. This not only causes manufacturers to produce more models of downlights, but also makes it more difficult for customers to choose.

### SUMMARY

A purpose of the present disclosure is to provide a downlight with multiple switchable lighting modes, so as to solve the problem proposed in the background art. The downlight with multiple switchable lighting modes provided in the present disclosure features selectable switching among three lighting modes.

Another purpose of the present disclosure is to provide an implementation method of the downlight with multiple switchable lighting modes.

To achieve the foregoing purpose, the present disclosure provides the following technical solution. A downlight with multiple switchable lighting modes includes a ring body. A light guide ring is disposed inside the ring body. A radiator is disposed above the light guide ring. A diffusion cover is disposed on the inner side of the radiator. A light guide plate is disposed above the diffusion cover. Reflective sheet is disposed above the light guide plate. A first light source is disposed between the ring body and the radiator. A second light source corresponding to the light guide plate is connected to an inner sidewall of the radiator. A backplate is connected above the ring body. A direct current (DC) wire is connected to the backplate.

To install the whole lamp, further, two symmetrically disposed springs are installed on the ring body.

To ensure tightness between the downlight and an installation surface, further, an outer cushion ring is connected to a top of an outer ring of the ring body.

To assemble the light guide ring and the ring body, further, an upward protruding ring is disposed on an inner ring of the ring body, and a ring slot corresponding to the protruding ring is disposed on the light guide ring.

To assemble the radiator and the light guide ring, further, an inner side of a top surface of the light guide ring is recessed downward to form a depression, and the radiator has a side wall, a horizontal wall bent inward from a bottom of the side wall and disposed on the top surface of the light guide ring, and a vertical wall bent downward from an inner side of the horizontal wall to engage with the depression of the light guide ring.

To assemble the diffusion cover and the radiator, further, a receiving space corresponding to the horizontal wall and vertical wall of the radiator is disposed on the diffusion cover.

Preferably, a limiting space is formed between the diffusion cover and the light guide ring, and the horizontal wall and the vertical wall of the radiator are positioned within the limiting space between the diffusion cover and the light guide ring.

To lock and assemble the whole lamp and enable assembly of the whole lamp to be simpler and quicker, further, an inner cushion ring is disposed at the top of the reflective sheet, and the backplate has a protruding portion extending downward from a top of the backplate, which acts on the inner cushion ring to apply compressive force.

In the present disclosure, further, the first light source is adhesively bonded to an inner wall of the ring body or to the backplate.

In the present disclosure, further, an implementation method of the downlight includes the following steps: assembling the light guide ring to the ring body by cooperating a ring slot of the light guide ring with a protruding ring of the ring body; assembling the radiator to the light guide ring by cooperating a horizontal wall and a vertical wall of the radiator with a top surface and a depression of the light guide ring respectively; assembling the diffusion cover to the radiator by cooperating a receiving space of the diffusion cover with the horizontal wall and the vertical wall of the radiator; placing the light guide plate above the diffusion cover; positioning the reflective sheet above the light guide plate; placing an inner cushion ring above the reflective sheet; applying compressive force to the inner cushion ring through the backplate, thereby pressing the light guide plate, diffusion cover, radiator, and light guide ring together; securing the backplate to the face body with one or more screws; employing light emitted by the second light source and passing through the light guide plate and diffusion cover as a primary illumination of the downlight; and employing light emitted by the first light source and passing through the light guiding ring as a secondary illumination of the downlight.

Compared with the prior art, the present disclosure has the following beneficial effects.
1. The second light source is disposed in the present disclosure, and the second light source emits light that passes through the light guide plate and the diffusion cover to serve as main lighting. The first light source is further provided in the present disclosure, and the first light source emits light that passes through the light guide ring to serve as auxiliary lighting or a night lamp. The first light source and the second light source may emit light simultaneously or separately, so that the downlight has three different selectable lighting modes, creating different light effects, meeting different requirements of customers, and reducing inventory models of downlight.
2. In the present disclosure, both the first light source and the second light source are of side lighting configurations, which effectively reduces the overall lamp height of the downlight, reduces packaging costs, and minimizes installation space requirements.
3. In the present disclosure, the whole lamp can be locked and assembled by using only four screws, so that assembly of the whole lamp is simpler and quicker.

### BRIEF DESCRIPTION OF THE DRAWINGS

FIG. 1 is an exploded structural schematic diagram of the present disclosure;

FIG. 2 is a partial cross-sectional structural schematic diagram of the present disclosure;

FIG. 3 is a partial cross-sectional structural schematic diagram of a ring body according to the present disclosure;

FIG. 4 is a partial cross-sectional structural schematic diagram of a light guide ring according to the present disclosure;

FIG. 5 is a partial cross-sectional structural schematic diagram of a radiator according to the present disclosure;

FIG. 6 is a partial cross-sectional structural schematic diagram of a diffusion cover according to the present disclosure;

FIG. 7 is a partial cross-sectional structural schematic diagram of the cooperation among a diffusion cover, a light guide ring, a ring body, and a radiator according to the present disclosure;

FIG. 8 is a partial cross-sectional structural schematic diagram according to Embodiment 3 of the present disclosure;

FIG. 9 is a partial cross-sectional structural schematic diagram according to Embodiment 4 of the present disclosure;

FIG. 10 is a schematic structural diagram of a radiator according to Embodiment 5 of the present disclosure; and

FIG. 11 is a partial cross-sectional structural schematic diagram according to Embodiment 5 of the present disclosure.

### DETAILED DESCRIPTION

The technical solutions in embodiments of the present disclosure will be clearly and completely described below with reference to drawings in the embodiments of the present disclosure. Apparently, the described embodiments are merely a part rather than all of the embodiments of the present disclosure. All other embodiments obtained by those skilled in the art on the basis of the embodiments of the present disclosure without requiring creative effort fall within the protection scope of the present disclosure.

### Embodiment 1

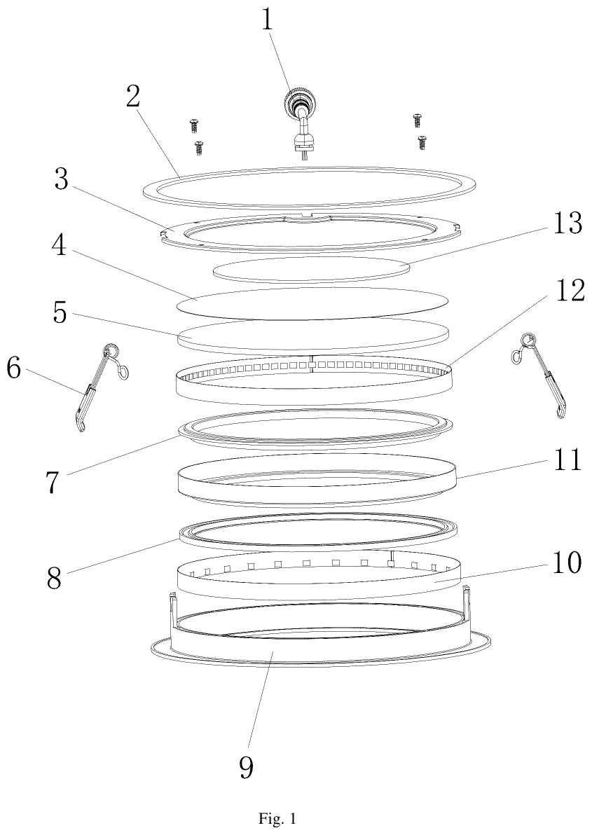

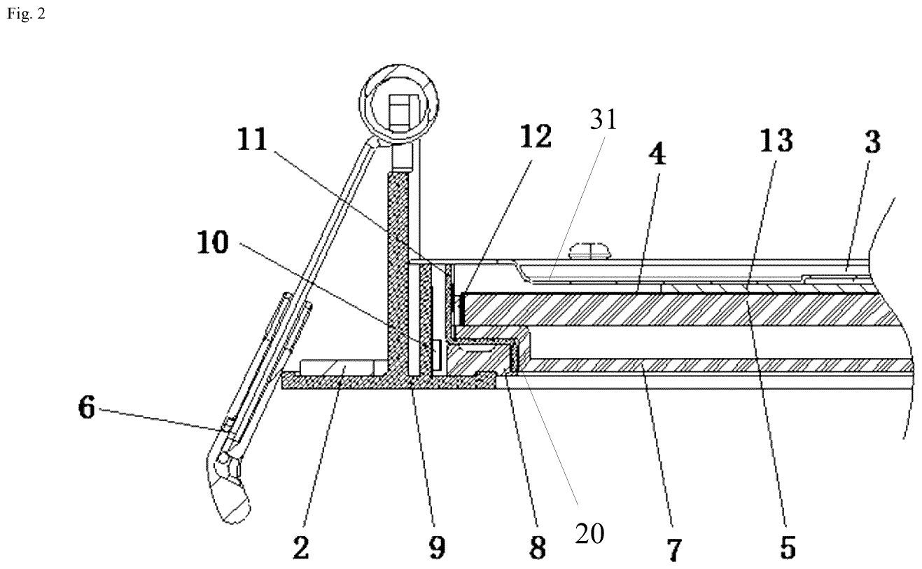

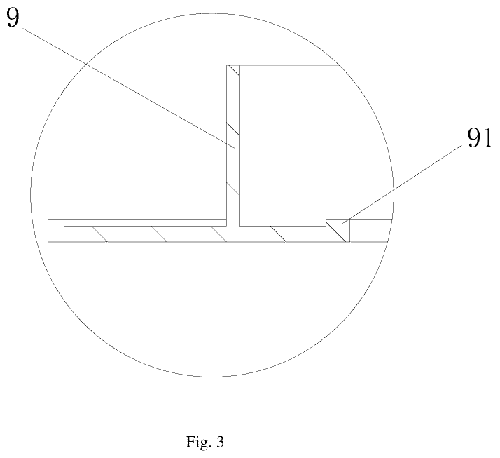

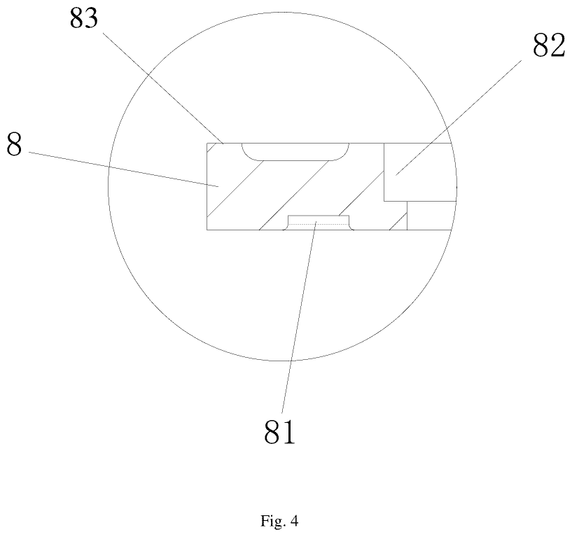

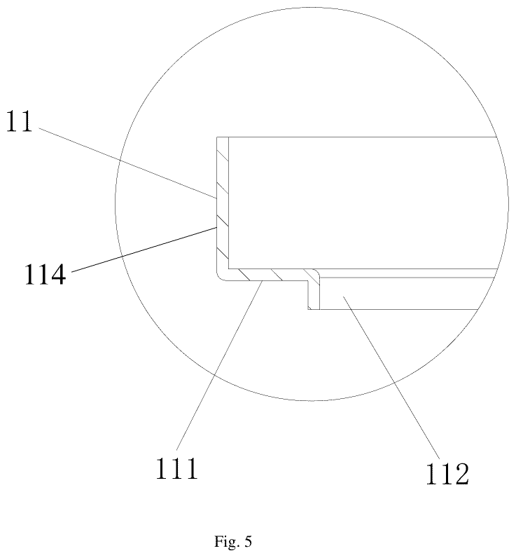

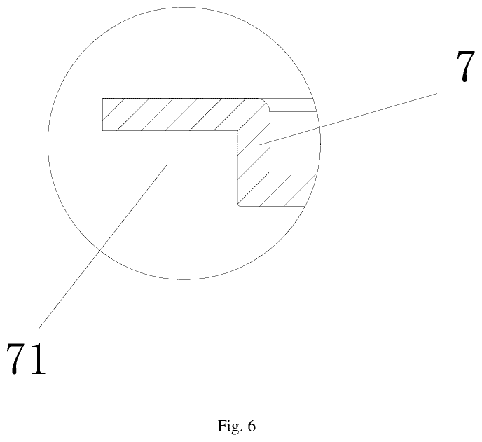

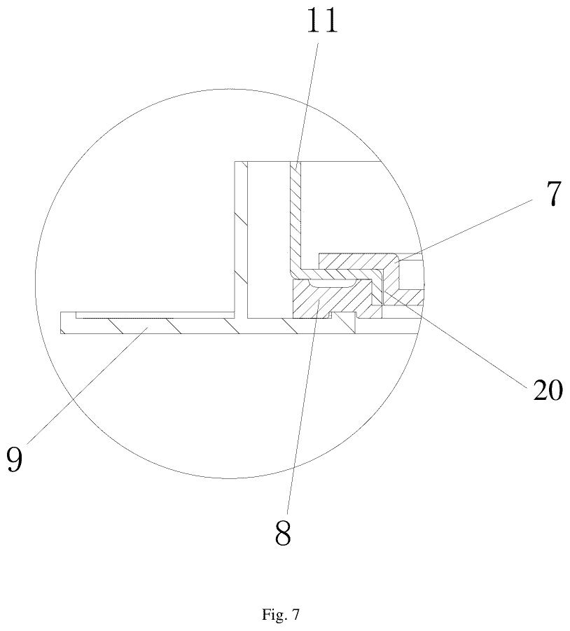

Referring to FIG. 1 to FIG. 7, the present disclosure provides the following technical solution. A downlight with multiple switchable lighting modes includes a ring body 9. A light guide ring 8 is disposed inside the ring body 9. A radiator 11 is disposed above the light guide ring 8. A diffusion cover 7 is disposed on the inner side of the radiator 11. A light guide plate 5 is disposed above the diffusion cover 7. Reflective sheet 4 is disposed above the light guide plate 5. A first light source 10 is disposed between the ring body 9 and the radiator 11. A second light source 12 corresponding to the light guide plate 5 is connected to an inner sidewall of the radiator 11. In this embodiment, the first light source 10 is adhesively bonded to an inner wall of the ring body. A backplate 3 is connected above the ring body 9. A direct current (DC) wire 1 is connected to the backplate 3. Both the first light source 10 and the second light source 12 are connected to the DC wire 1 and can be controlled via wall switches or other methods.

By adopting the foregoing technical solution, the second light source 12 is provided in the present disclosure, and the second light source 12 emits light that passes through the light guide plate 5 and the diffusion cover 7 to serve as main lighting. The first light source 10 is further provided in the present disclosure, and the first light source 10 emits light that passes through the light guide ring 8 to serve as auxiliary lighting or a night lamp. The first light source 10 and the second light source 12 may emit light simultaneously or separately, so that the downlight has three different selectable lighting modes, creating different light effects, meeting different requirements of customers, and reducing inventory models. In the present disclosure, both the first light source 10 and the second light source 12 are of side lighting configurations, which effectively reduces the overall height of the downlight, reduces packaging costs, and minimizes installation space requirements.

Specifically, two symmetrically disposed springs 6 are installed on the ring body 9.

By adopting the foregoing technical solution, the whole lamp can be installed.

Specifically, an outer cushion ring 2 is connected to a top of an outer ring edge of the ring body 9.

By adopting the foregoing technical solution, the tightness between the downlight and the installation surface is ensured.

### Embodiment 2

Differences between this embodiment and Embodiment 1 lie in that: Specifically, an upward protruding ring 91 is disposed on an inner ring of the ring body 9, and a ring slot 81 corresponding to the protruding ring 91 is disposed on the light guide ring 8.

By adopting the foregoing technical solution, the light guide ring 8 is assembled with the ring body 9 through the cooperation of the ring slot 81 with the protruding ring 91.

Preferably, an inner side of a top surface 83 of the light guide ring 8 is recessed downward to form a depression 82, and the radiator 11 has a side wall 114, a horizontal wall 111 bent inward from a bottom of the side wall 114 and disposed on the top surface of the light guide ring 8, and a vertical wall 112 bent downward from an inner side of the horizontal wall 111 to cooperate with the depression 82 of the light guide ring 8.

By adopting the foregoing technical solution, the radiator 11 is assembled with the light guide ring 8 through the cooperation of the horizontal wall 111 and the vertical wall 112 with the top surface 83 and depression 82 respectively.

Specifically, a receiving space 71 corresponding to the horizontal wall 111 and the vertical wall 112 is disposed on the diffusion cover 7.

By adopting the foregoing technical solution, the diffusion cover 7 is assembled with the radiator 11 through the cooperation of the receiving space 71 with the lower hem 112.

Preferably, a limiting space 20 is formed between the diffusion cover 7 and the light guide ring 8, and the horizontal wall 111 and the vertical wall 112 of the radiator 11 are positioned within the limiting space 20 between the diffusion cover 7 and the light guide ring 8.

Specifically, an inner cushion ring 13 is disposed at a top of the reflective sheet 4. The backplate 3 has a protruding portion 31 extending downward from a top of the backplate 3. The protruding portion 31 acts on the top of the inner cushion ring 13 to apply compressive force to press and fix the light guide plate 5, the diffusion cover 7, the radiator 11, and the light guide ring 8 together. The backplate 3 and the ring body 9 are in locking connection by using screws.

By adopting the foregoing technical solution, in the present disclosure, the whole lamp can be locked and assembled by using only four screws, so that assembly of the whole lamp is simpler and quicker.

### Embodiment 3

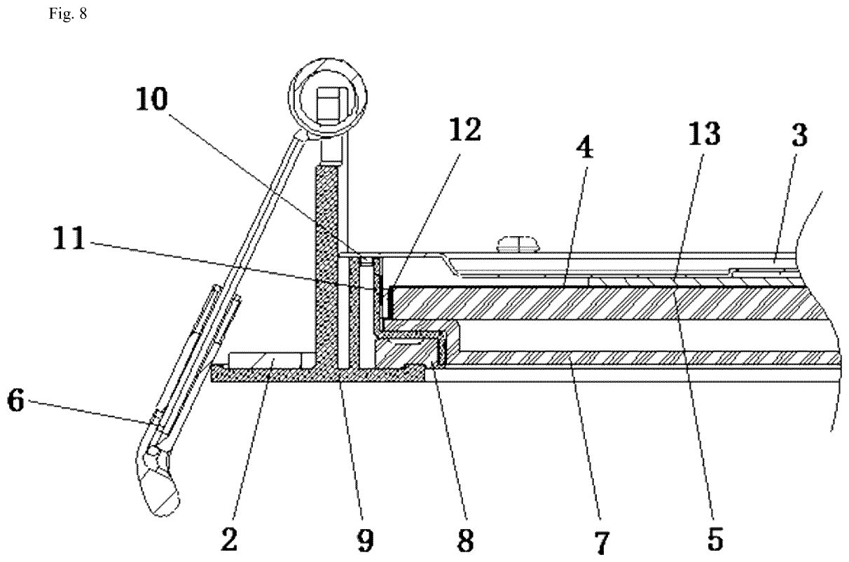

Referring to FIG. 8, differences between this embodiment and Embodiment 1 lie in that: Specifically, the first light source 10 is adhesively bonded to the backplate 3.

By adopting the foregoing technical solution, the first light source 10 adopts direct-lit lighting.

### Embodiment 4

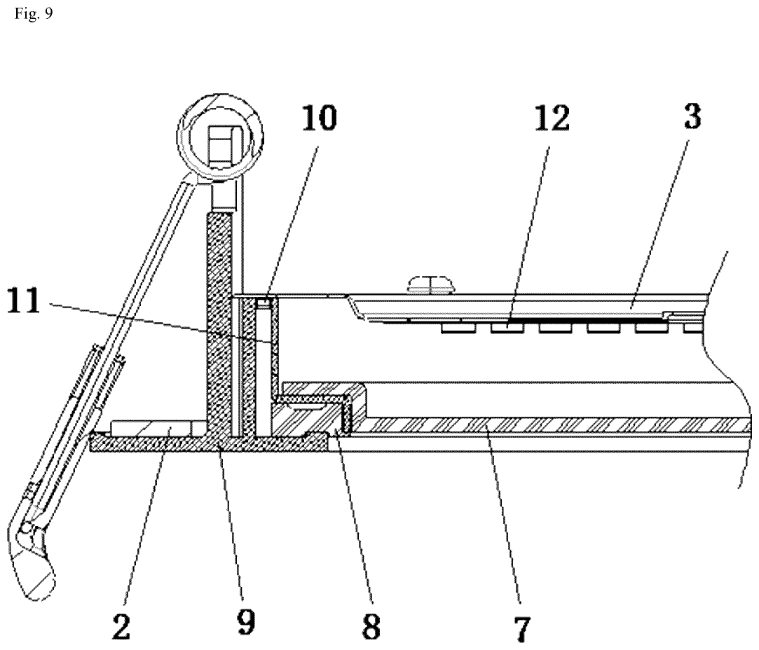

Referring to FIG. 9, differences between this embodiment and Embodiment 3 lie in that: Specifically, the second light source 12 is adhesively bonded to the backplate 3. In this embodiment, the light guide plate 5, the reflective sheet 4, and the inner cushion ring 13 are not required, and the light guide ring 8, the ring body 9, the radiator 11, and the diffusion cover 7 may be adhesively bonded together by using glue.

This embodiment illustrates that direct-lit lighting may also be implemented by adopting the structure in this application.

### Embodiment 5

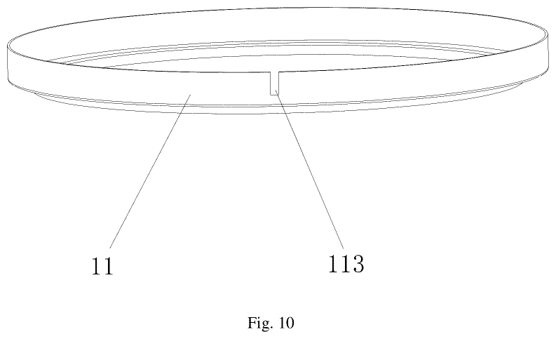

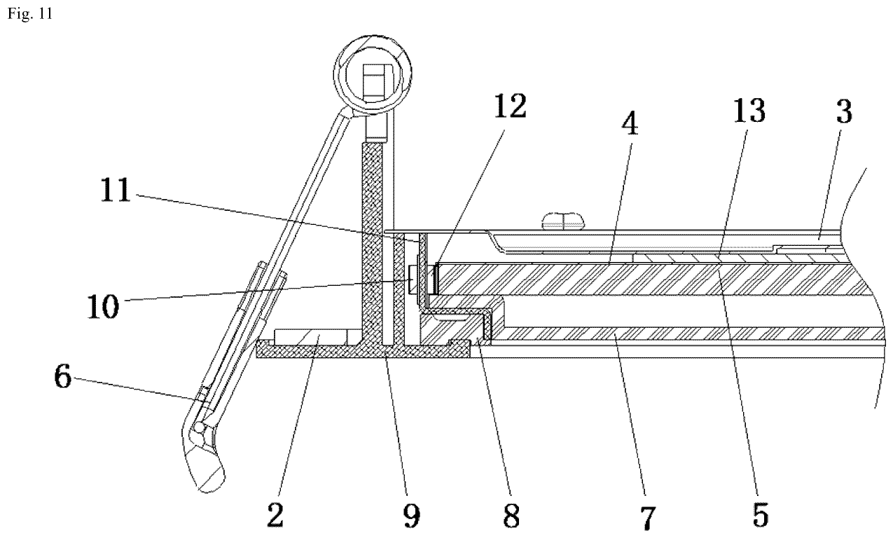

Referring to FIG. 10 and FIG. 11, differences between this embodiment and Embodiment 1 lie in that: Specifically, a notch slot 113 is disposed on the radiator 11. The first light source 10 and the second light source 12 share and are connected to a same flexible light source plate. The second light source 12 of the flexible light source plate is first adhesively bonded to an inner wall of the radiator 11, and the first light source 10 of the flexible light source plate is adhesively bonded to an outer wall of the radiator 11 after the flexible light source plate passes through the notch slot 113 from the inner wall to the outer wall of the radiator 11.

By adopting the foregoing technical solution, the first light source 10 and the second light source 12 share one flexible light source plate, thereby reducing use of a conductor, improving the efficiency of light source assembly, and reducing costs.

### Embodiment 6

Further, an implementation method of the downlight with multiple switchable lighting modes includes the following steps:
(1) assembly: the light guide ring 8 is assembled with the ring body 9 through the cooperation of the ring slot 81 with the protruding ring 91, the radiator 11 is assembled with the light guide ring 8 through the cooperation of the horizontal wall 111 and the vertical wall 112 with the top surface 83 and the depression 82 respectively, the diffusion cover 7 is assembled with the radiator 11 through the cooperation of the receiving space 71 with the horizontal wall 111 and the vertical wall 112, the light guide plate 5 is placed above the diffusion cover 7, the reflective sheet 4 is placed above the light guide plate 5, the inner cushion ring 13 is placed above the reflective sheet 4, and the backplate 3 and the ring body 9 are in locking connection by using screws;
(2) main lighting: the second light source 12 emits light that passes through the light guide plate 5 and the diffusion cover 7 to serve as main lighting; and
(3) auxiliary lighting: the first light source 10 emits light that passes through the light guide ring 8 to serve as auxiliary lighting.

In conclusion, the second light source 12 is provided in the present disclosure, and the second light source 12 emits light that passes through the light guide plate 5 and the diffusion cover 7 to serve as main lighting. The first light source 10 is further provided in the present disclosure, and the first light source 10 emits light that passes through the light guide ring 8 to serve as auxiliary lighting or a night lamp. The first light source 10 and the second light source 12 may emit light simultaneously or separately, so that the downlight has three different selectable lighting modes, creating different light effects, meeting different requirements of customers, and reducing inventory models. In the present disclosure, both the first light source 10 and the second light source 12 are of side lighting structures, which effectively reduces the overall lamp height of the downlight, reduces packaging costs, and minimizes installation space requirements. In the present disclosure, the whole lamp can be locked and assembled by using only four screws, so that assembly of the whole lamp is simpler and quicker.

Although the embodiments of the present disclosure have already been shown and described, it will be understood by those skilled in the art that various changes, modifications, substitutions and variations can be made to these embodiments without departing from the principle and spirit of the present disclosure. The scope of the present disclosure is defined by claims and equivalents thereof.

1. A downlight, comprising a ring body, wherein a light guide ring is disposed inside the ring body, a radiator is disposed above the light guide ring, a diffusion cover is disposed on an inner side of the radiator, a light guide plate is disposed above the diffusion cover, reflective sheet is disposed above the light guide plate, a first light source is disposed between the ring body and the radiator, a second light source corresponding to the light guide plate is connected to an inner wall of the radiator, a backplate is connected above the ring body, and a direct current (DC) wire is connected to the backplate.

2. The downlight according to claim 1, wherein two symmetrically disposed springs are installed on the ring body.

3. The downlight according to claim 1, wherein an outer cushion ring is connected to a top of an outer ring of the ring body.

4. The downlight according to claim 1, wherein an upward protruding ring is disposed on an inner ring of the ring body, and a ring slot corresponding to the protruding ring is disposed on the light guide ring.

5. The downlight according to claim 1, wherein an inner side of a top surface of the light guide ring is recessed downward to form a depression, and the radiator has a side wall, a horizontal wall bent inward from a bottom of the side wall and disposed on the top surface of the light guide ring, and a vertical wall bent downward from an inner side of the horizontal wall to engage with the depression of the light guide ring.

6. The downlight according to claim 5, wherein a limiting space is formed between the diffusion cover and the light guide ring, and the horizontal wall and the vertical wall of the radiator are positioned within the limiting space between the diffusion cover and the light guide ring.

7. The downlight according to claim 1, wherein an inner cushion ring is disposed at a top of the reflective sheet.

8. The downlight according to claim 7, wherein the backplate has a protruding portion extending downward from a top of the backplate, which acts on the inner cushion ring to apply compressive force.

9. The downlight according to claim 1, wherein the first light source is adhesively bonded to an inner wall of the ring body or to the backplate.

10. An implementation method of the downlight according to claim 1, comprising:
assembling the light guide ring to the ring body by cooperating a ring slot of the light guide ring with a protruding ring of the ring body;
assembling the radiator to the light guide ring by cooperating a horizontal wall and a vertical wall of the radiator with a top surface and a depression of the light guide ring respectively;
assembling the diffusion cover to the radiator by cooperating a receiving space of the diffusion cover with the horizontal wall and the vertical wall of the radiator;
placing the light guide plate above the diffusion cover;
positioning the reflective sheet above the light guide plate;
placing an inner cushion ring above the reflective sheet;
applying compressive force to the inner cushion ring through the backplate, thereby pressing the light guide plate, diffusion cover, radiator, and light guide ring together;
securing the backplate to the face body with one or more screws;
employing light emitted by the second light source and passing through the light guide plate and diffusion cover as a primary illumination of the downlight; and
employing light emitted by the first light source and passing through the light guiding ring as a secondary illumination of the downlight.
